(19) United States
(12) Patent Application Publication
(10) Pub. No.: US 2012/0222821 A1
(43) Pub. Date: Sep. 6, 2012

(54) DEVICE FOR TURNING UP A TIRE-BUILDING PART ON A TIRE-BUILDING DRUM USING A ROLLER LEVER

(75) Inventors: Andreas Hanke, Hannover (DE); Karl-Heinz Pawlik, Hannover (DE)

(73) Assignee: CONTINENTAL REIFEN DEUTSCHLAND GMBH, Hannover (DE)

(21) Appl. No.: 13/508,915

(22) PCT Filed: Sep. 27, 2010
(86) PCT No.: PCT/EP10/64204

§ 371 Date: May 9, 2012

(30) Foreign Application Priority Data
Dec. 9, 2009 (DE) 102009044830.6

(51) Int. Cl. B29D 30/24

(52) U.S. Cl. 156/414

(57) ABSTRACT

The invention relates to a device for turning up a tyre-building part on a tyre-building drum using a roller lever. In order to produce a device for turning up a tyre-building part on a tyre-building drum, by means of which the tyre-building part is turned up without defects, in particular an unintended crease formation in the lateral wall, according to the invention the roller lever (5) comprises a lifting roller (7) on the side thereof directed towards the drum axis (3) of the tyre-building drum (2), opposite which a ramp-shaped component (12) is arranged. As the tyre-building part (1) is turned up, the roller lever (5) is raised by means of the lifting roller (7) to a pre-position, wherein, as the roller lever (5) is lifted to the pre-position, the crimping roller (6) is spaced in such a way that the crimping roller (6) is substantially exclusively in contact with the tyre-building part (1) and the roller rolls along the tyre-building part (6).

The invention relates to a device for turning up a tyre-building part on a tyre-building drum using a roller lever.

In the conventional production of new tyres, one production step takes place on a tyre-building drum, on which the tyre carcass, which initially rests flat on the drum, is cambered by means of an expansion process. The actual carcass cambering process is accomplished by means of a central bellows, for example, which expands the central area of the carcass. In this process, the two outer side walls on the cambered carcass are then turned up and, in the process, folded around the bead cores. This process of folding up the tyre side walls is accomplished either with what are referred to as lateral cambering bellows or with a roller lever system arranged in a ring on the circumference. When lateral cambering bellows are used, two inflatable bellows arranged in the region of the side wall plies are inflated, thereby pressing the side walls against the cambered carcass. The turn-up process with the aid of lateral cambering bellows can have the disadvantage that the action of said bellows does not extend into the shoulder areas of the tyre blank, thereby rendering manual finishing work necessary. Moreover, the lateral cambering bellows are subject to severe wear, requiring correspondingly frequent replacement, which is associated with a very large expenditure of time.

Turning up the side walls with the aid of a roller lever system is disclosed in DE 199 34 791 C1, for example. In this device, the roller lever system is spread apart by means of a pneumatic drive consisting of two separate pneumatic cylinders. The two pneumatic cylinders are supplied separately with compressed air, thereby spreading the tyre lever system apart and turning up the side walls on the carcass as a result.

One significant disadvantage with this principle is that, in the case of sensitive thin side walls and certain tyre designs, the opposed rotary motion of the rollers can lead to impermissible defects, in the form of creasing or displacement of material in the tyre blank for example. Owing to the contact between the circumferential surfaces of the rollers and the core clamping segments or other parts of the tyre-building drum, for example, a rotary motion of the rollers is inevitably generated at the beginning of the roller lever movement, pushing the tyre-building parts into the gap between the core segment and the roller and thereby promoting impermissible creasing, especially in the case of thin materials. This creasing can lead to rejection of the tyre blank.

It is the underlying object of the invention to provide a device for turning up a tyre-building part on a tyre-building drum, by means of which device the tyre-building part is turned up without defects, in particular unintentional creasing in the side wall.

The object is achieved, in accordance with the preamble and the characterizing features of claim 1, by virtue of the fact that the roller lever has a lifting roller on the side thereof directed toward the drum axis of the tyre-building drum, opposite which a ramp-shaped component is arranged, wherein, in the process of turning up the tyre component, the roller lever is raised by means of the lifting roller to a preliminary position, wherein, as the roller lever is raised to the preliminary position, the crimping roller has a clearance such that the crimping roller is substantially exclusively in contact with the tyre-building part and the roller rolls along the tyre-building part.

One particular advantage of the invention may be regarded as the fact that creases and other defects during the turning up of the side wall and of the bead components are avoided in an effective manner by means of the device according to the invention. Owing to the lifting roller and the raising of the roller lever to the preliminary position, the roller or crimping roller on the roller lever has no contact with surrounding components of the tyre-building drum and, as a result, the roller does not roll on the surrounding components, nor does an opposed rotary motion of the roller unintentionally crease or compress the overlying tyre-building part. Instead, the roller is now substantially exclusively in contact with the overlying tyre-building part and, in the initial phase of the working stroke or during the preparation of the turning up of the tyre-building part, thus rolls on the tyre-building part. This initial phase of the working stroke comprises the raising of the roller levers as far as the preliminary position. In this way, production defects in the tyre, especially in the tyre side wall, are to a large extent prevented. Moreover, it is possible to manufacture tyres in a wider dimensional range than with the previous prior-art method.

In an advantageous development of the invention, provision is made for the ramp-shaped component to have a contour of S-shaped cross section, thereby ensuring that the roller lever is raised continuously from an initial position into the preliminary position. The S-shaped contour of the ramp-shaped component ensures that the roller lever is extended into a preliminary position, which is used to stabilize the tyre blank in the bead region during the cambering process. This ensures that the side wall is securely joined to the tyre bead during the cambering process and during the application of pressure by the crimping rollers.

In another advantageous development of the invention, provision is made for the roller lever to be raised into the preliminary position by means of a separate first pneumatic cylinder, and for the remaining working stroke of the roller lever to be performed by means of a second pneumatic cylinder.

This ensures that the roller lever is raised continuously to the predetermined preliminary position. Moreover, it is possible to set a specific working pressure at the separate first pneumatic cylinder for the preliminary position, with which pressure the crimping rollers are to stabilize the side wall on the tyre bead. The remaining working stroke of the roller levers can then be carried out at a second working pressure.

In another advantageous development of the invention, provision is made for the ramp-shaped component to comprise a locking feature for locking the roller lever. Locking the levers is a simple means of avoiding a collision with other machine components during the rotation of the tyre-building drum. Without a locking feature, the forces associated with rotation might move the roller levers to spread apart prematurely.

In another advantageous development of the invention, provision is made for the locking feature to comprise a recess in the ramp-shaped component, into which recess a locking element arranged on the roller lever engages in the locked state. With such a locking element, the roller levers can be fixed in the retracted state in a simple manner.

In another advantageous development of the invention, provision is made for the roller lever to be automatically unlocked when the roller lever is moved in the axial direction, and then for the roller lever to be raised to the preliminary position.

As a result, there is no need for a separate control arrangement, by means of which the roller levers would have to be unlocked.

In another advantageous development of the invention, provision is made for the lifting roller to be arranged substantially half way along the roller lever, on the underside of the latter.

By virtue of the lever action, the roller lever is raised into the preliminary position in an effective manner on the side of the crimping roller.

In another advantageous development of the invention, provision is made for the roller lever to have at least one recess on the upper side thereof to accommodate a belt.

The belts are a simple means of ensuring that the roller levers return to the starting position thereof after the cambering process.

In another advantageous development of the invention, provision is made for the roller to be provided with a nonstick coating. This ensures that the roller rolls on the tyre-building part and that this material does not stick to the roller.

In another advantageous development of the invention, provision is made for the tyre-building drum to comprise a multiplicity of roller levers arranged symmetrically with respect to the axis. This ensures that the side wall of the tyre to be produced is rolled up uniformly at all points.

In another advantageous development of the invention, provision is made for the roller levers to be coupled rotatably to an axially movable component of the tyre-building drum and to move part during the turn-up process.

The invention will be explained in greater detail with reference to an embodiment.

In the drawing:

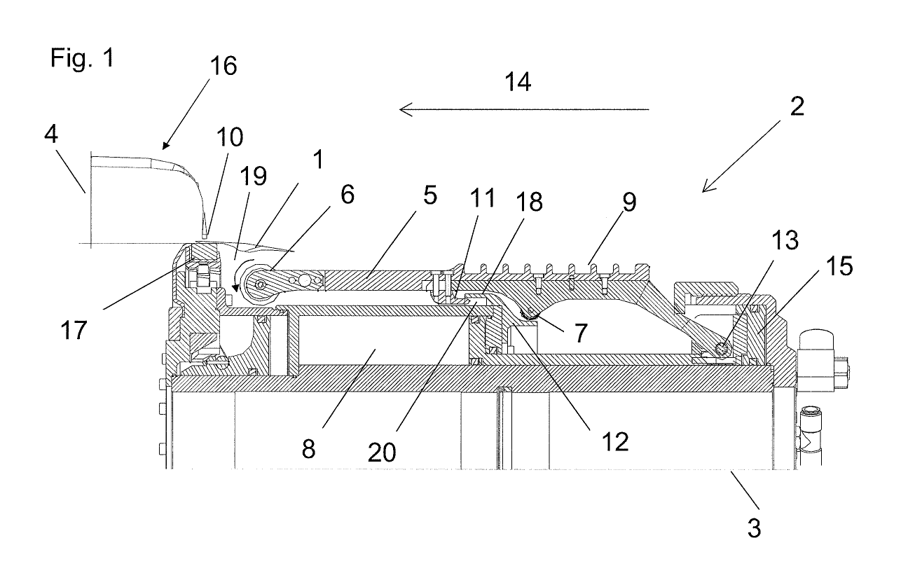

FIG. 1 shows the device according to the invention in the starting position.

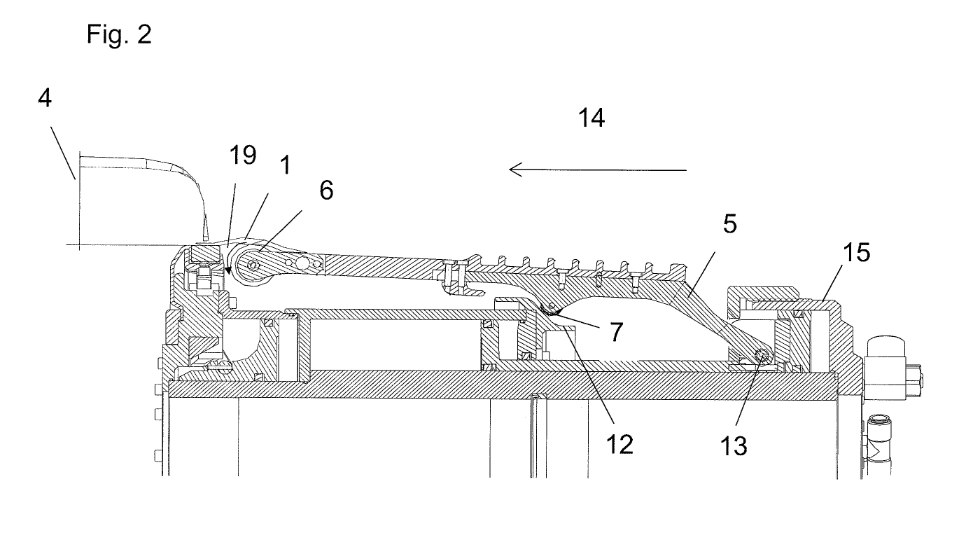

FIG. 2 shows the device as the roller lever is moved into the preliminary position.

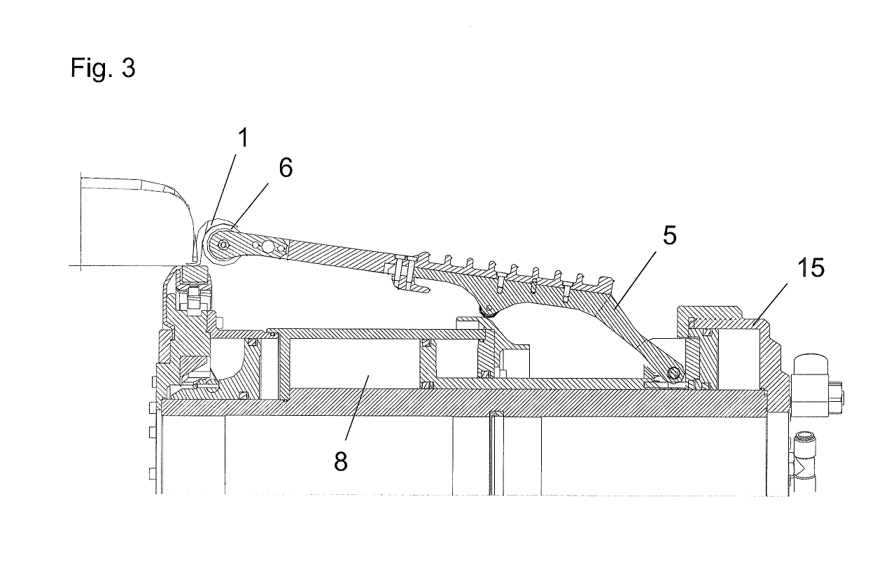

FIG. 3 shows the device, in which the roller lever has been moved into the preliminary position.

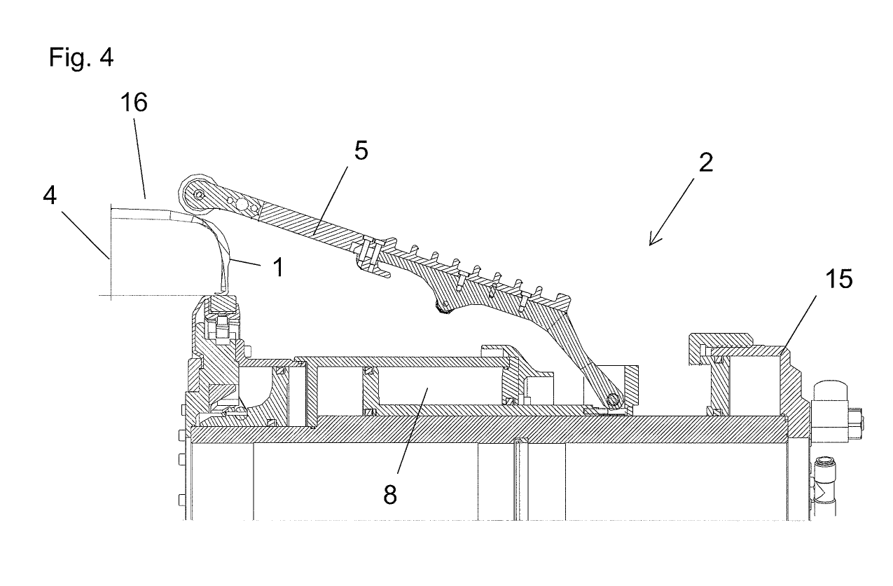

FIG. 4 shows the device, in which the tyre side wall has been turned up completely and the remaining working stroke is complete.

FIG. 1 shows a partial cutaway view of a tyre-building drum 2 with the device according to the invention for turning up a tyre-building part 1, which substantially forms the tyre side wall of the tyre to be produced. The tyre-building drum 2 is constructed substantially symmetrically with respect to the drum axis 3 and to the drum center 4, for which reason the respective components on the opposite side are not shown in the figure.

Two rollers 6 are arranged at one end of the roller lever 5, although only one roller is visible in this side view. The second roller lies directly behind the first roller, with both rollers being arranged symmetrically in a plan view of the roller lever 5 and being rotatably connected to the roller lever 5 by means of a rolling contact bearing assembly. A core clamping segment 17 is arranged opposite the roller lever 5. In a first working step, the segment 17 moves radially outward in order to clamp the tyre core 10. The roller lever 2 is rotatably mounted at the pivot 13 and is moved into the preliminary position illustrated in FIG. 3 by actuation of the pneumatic cylinder 15 in the axial direction 14. First of all, a process of preparing for turning up the tyre-building part, or the process comprising the initial phase of the working stroke, which ends with the positioning of the roller lever in the preliminary position, takes place. The aim of this initial phase of the working stroke is to position the rollers 6 directly in the lower area of the tyre bead. Only then are the side walls turned up in a process in which the rollers 6 roll the tyre-building part 1 up against the cambered tyre carcass 16. This turn-up process is accomplished by means of a further axial movement of the roller lever 2, which is as it were spread apart during this movement. The roller lever 5 has the lifting roller 7 on the underside thereof, opposite which is arranged the S-shaped ramp-shaped component 12. The ramp-shaped component 12 is arranged on the pneumatic cylinder 8. A locking feature 18 with a corresponding recess 20 is likewise arranged on the ramp-shaped component 12. The locking element 11, which is connected to the roller lever 5, engages in this recess 20. In the starting position of the roller lever 5, said roller is thereby securely locked to the locking feature 18 of the ramp-shaped component 12. A first pneumatic cylinder 15, by means of which the roller lever is raised into the preliminary position, is arranged at the rear end of the roller lever 5.

The remaining working stroke of the roller lever 5 is then carried out with pneumatic cylinder 8.

The roller 6 is in contact substantially exclusively with the overlying tyre-building part 1, and therefore the roller 6 rolls along the tyre-building part 1 in direction of rotation 19. As a result, the roller 6 does not push the material of the tyre-building part 1 ahead of it and there is no impermissible creasing, which would lead to rejection of the tyre. After this initial phase of the working stroke or of the positioning of the roller lever to the preliminary position, the actual turning up of the side walls and further fabrication of the tyre in accordance with a conventional method takes place.

FIG. 2 shows the process in which the roller lever 5 is raised into the preliminary position. By means of pneumatic cylinder 15, the roller lever is moved in axial direction 14. By virtue of the s-shaped contour of the ramp-shaped part 12, the roller lever is raised to the preliminary position by the lifting roller 7. During this process, the crimping roller 6 comes into contact with the tyre side wall 1 and, as a result, the crimping roller 6 rolls on the tyre component 1 in direction of rotation 19.

FIG. 3 shows the process in which the roller lever 5 has been raised into the preliminary position thereof. The crimping rollers 6 have folded over the tyre component 1 or tyre side wall 1 and joined it securely to the tyre bead.

FIG. 4 shows the process in which the tyre side wall has being fully raised against the tyre carcass 16. The roller lever 5 has been moved into the outermost position thereof by means of the pneumatic cylinder 8 in order to join the tyre side walls securely to the tyre carcass.

The roller levers 5 are then moved back into the starting position thereof, and the complete tyre carcass is removed from the tyre-building drum 2. The vehicle tyre is then finished by a conventional production method.

### LIST OF REFERENCE SIGNS

### Part of the Description

1 tyre-building part
2 tyre-building drum
3 drum axis
4 drum center
5 roller lever
6 rollers or crimping roller
7 lifting roller
8 second pneumatic cylinder
9 recess on the upper side of the roller lever
10 tyre core
11 locking element on the roller lever
12 ramp-shaped component
13 pivot
14 axial direction
15 first pneumatic cylinder for preliminary position
16 tyre carcass
17 core clamping segment
18 locking feature on the ramp-shaped component
19 direction of rotation of the rollers
20 recess on the ramp-shaped component

1. A device for turning up a tyre-building part (1) on a tyre-building drum (2) using at least one roller lever (5), on which at least one rotatably mounted crimping roller (6) is arranged, wherein the roller lever (5) is arranged rotatably on a component which can be moved in an axial direction relative to the drum axis (3), wherein the roller lever (5) turns up the tyre component (1) in a radial direction on a tyre blank, and the tyre component (1) is thereby folded over and joined to the tyre blank, characterized in that the roller lever (5) has a lifting roller (7) on the side thereof directed toward the drum axis (3) of the tyre-building drum (2), opposite which a ramp-shaped component (12) is arranged, wherein, in the process of turning up the tyre component (1), the roller lever (5) is raised by means of the lifting roller (7) to a preliminary position, wherein, as the roller lever (5) is raised to the preliminary position, the crimping roller (6) has a clearance such that the crimping roller (6) is substantially exclusively in contact with the tyre-building part (1) and the roller rolls along the tyre-building part (6).

2. The device as claimed in claim 1, characterized in that the ramp-shaped component (12) has a contour of S-shaped cross section, thereby ensuring that the roller lever (5) is raised continuously from an initial position into the preliminary position.

3. The device as claimed in claim 1, characterized in that the roller lever (5) is raised into the preliminary position by means of a separate first pneumatic cylinder (15), and the remaining working stroke of the roller lever (5) is performed by means of a second pneumatic cylinder (8).

4. The device as claimed in claim 1, characterized in that the ramp-shaped component (12) comprises a locking feature (18) for locking the roller lever (5).

5. The device as claimed in claim 1, characterized in that the locking feature (18) comprises a recess (20) in the ramp-shaped component (12), into which recess a locking element (11) arranged on the roller lever (5) engages in the locked state.

6. The device as claimed in claim 1, characterized in that the roller lever (5) is automatically unlocked when the roller lever (5) is moved in the axial direction (14), and the roller lever is then raised to the preliminary position.

7. The device as claimed in claim 1, characterized in that the lifting roller (7) is arranged substantially half way along the roller lever (5), on the underside of the latter.

8. The device as claimed in claim 1, characterized in that the roller lever (5) has at least one recess (9) on the upper side thereof to accommodate a belt.

9. The device as claimed in claim 1, characterized in that the crimping roller (6) is provided with a nonstick coating.
